(19) United States
(12) Patent Application Publication
(10) Pub. No.: US 2025/0118910 A1
(43) Pub. Date: Apr. 10, 2025

(54) COMPRESSIBLE ELECTRICAL ASSEMBLIES WITH DIVARICATED-CUT SECTIONS

(71) Applicant: CORNING OPTICAL COMMUNICATIONS RF LLC, GLENDALE, AZ (US)

(72) Inventors: Donald Andrew Burris, Peoria, AZ (US); Thomas Edmond Flaherty, IV, Surprise, AZ (US); Daniel Michael Grabowski, Goodyear, AZ (US)

(21) Appl. No.: 18/985,167

(22) Filed: Dec. 18, 2024

Related U.S. Application Data
(63) Continuation of application No. 17/522,416, filed on Nov. 9, 2021, now Pat. No. 12,212,083.
(60) Provisional application No. 63/119,578, filed on Nov. 30, 2020.

(51) Int. Cl. H01R 13/24; H01R 12/71; H01R 13/03

(52) U.S. Cl. CPC H01R 11/09; H01R 12/523; H01R 12/58; H01R 2103/00

(57) ABSTRACT

Various configurations of compressible electrical assemblies and connector systems are disclosed herein. Each variation of the compressible electrical assemblies includes at least one dielectric, an inner conductor and an outer conductor. Each inner and outer conductor may be configured as a compressible contact. One embodiment of a compressible electrical assembly includes an inner compressible contact, and outer compressible contact and a dielectric disposed at least partially between the inner compressible contact and the outer compressible contact. Each compressible contact also has a divaricated-cut section with a plurality of cuts defined by at least one cut angle measured between a pair of opposing inner surfaces.

### CROSS-REFERENCE TO RELATED APPLICATION

This application is a continuation of U.S. patent application Ser. No. 17/522,416 filed Nov. 9, 2021, which claims the benefit of priority of U.S. Provisional Application Ser. No. 63/119,578, filed Nov. 30, 2020, the content of which is relied upon and incorporated herein by reference in its entirety.

### BACKGROUND

The present disclosure generally relates to compressible electrical assemblies, and particularly compressible electrical assemblies, having one or more compressible electric contacts with divaricated-cut sections.

Coaxial transmission mediums for conveying information at microwave frequencies are often characterized by their relatively small size. Their size, however, is not only a consequence of the operation frequency range, but is also particularly attributable to the applications and environments of the systems in which the coaxial transmission mediums are employed. For example, such systems may be found in sophisticated super conductor applications in which the size, density of packaging, and weight of microwave electronic systems must be established as small and light to the extent reasonably possible.

In another specialized configuration for coupling together two coaxial transmission mediums (such as by coupling adjacent modules), the inner conductor mating element of each medium is configured as male, and a double-ended female component (sometimes termed a “bullet”) is configured to receive the male mating elements to complete the center conductor connection at the junction. Each female center conductor element of the bullet is typically provided with at least a pair of diametrically opposed longitudinal slots to affect a spring bias (particularly when opposing sides of the element are normally slightly sprung toward one another) for grasping the male center conductor elements of the adjoining modules.

Considering the foregoing, there are still various needs for providing methods of connecting a transmission line ground and a contact, using a tubular housing and center contact, manufactured in such a way as to account for the various tolerances which stack up between printed circuit boards, providing methods of machining housings for high volume application, and providing 20 Ohm interconnects.

### SUMMARY

Embodiments disclosed herein are directed to electrical connectors and compressible electrical assemblies or coupling together coaxial transmission media, such as printed circuit boards, and associated methods. Embodiments disclosed herein are particularly suited for applications in which connectors connect coaxial transmission media, which operate, or which are operable in the microwave frequency range and similar frequency regimes. These embodiments are also suited for working as a super conductor in cryogenic connector applications and can apply to an array of frequencies as tuned for each individual application. Tubular designs of certain embodiments are further configured such that forces to mate the housing and ground component physical diameters are drastically reduced to accommodate a large number of interconnections between printed circuit boards in a highly dense, or closely spaced arrangement.

Advantages of the concepts disclosed herein include, but are not limited to allowing impendence of the system to be 20 Ohm, providing reduced costs due to efficient manufacturing met, particularly with respect to cutting, weight reduction of the connector assemblies, providing the housings with capability to have a negligible insertion and retention force, and providing for the transmission of very low power RF signals, particularly at cryogenic temperatures.

The compressible electrical assemblies may include a conductive housing, one or more dielectrics, and conductors, some of which may be configured as compressible contacts. Each compressible contact may thus be configured to vary its length, compensate for tolerance ranges/deviations of mating center conductors or cables, and maintain constant electrical/mechanical connection upon assembly. The properties of the compressible contacts disclosed herein are due, in part, to manufacturing the contacts using precision cutting methods, which result in a plurality of cut sections. Such methods include, but are not limited to, laser cutting, electroforming, and/or electro-etching. Regardless of the precision cutting method used, the contacts disclosed herein are preferably designed, using divaricating patterns, such that each contact has a plurality of cut sections in its final form.

The term “divaricated-cut”, as used herein, describes an area or section which has been cut in a way that allows a compressible contact to have contact sections configured to form open areas after cutting when in a substantially relaxed state, nest or collapse inwardly to form slots when compressive force is applied to the compressible contact, resulting in a substantially compressed state. The compressible electrical contacts are also configured maintain a flexible and substantially tubular form when transitioning from a substantially relaxed state to a substantially compressed state, despite the presence of the plurality of cut sections.

According to one aspect, a compressible electrical assembly includes an inner compressible contact, having a first inner contact end, a second inner contact end opposing the first inner contact end, and a medial inner portion positioned between the first inner contact end and the second inner contact end; an outer compressible contact, comprising a first outer contact end, a second outer contact end opposing the first outer contact end, and a medial outer portion positioned between the first outer contact end and the second outer contact end; and a dielectric substantially disposed between the medial inner portion and the medial outer portion. In addition, defined in each of the first inner contact end, the second inner contact end, the first outer contact end, and the second outer contact end is a plurality of divaricated cuts.

According to another aspect, a compressible electrical assembly includes an inner compressible contact, having a first inner contact end, a second inner contact end opposing the first inner contact end, and a medial inner portion positioned between the first inner contact end and the second inner contact end; an outer compressible contact, comprising a first outer contact end, a second outer contact end opposing the first outer contact end, and a medial outer portion positioned between the first outer contact end and the second outer contact end; and a dielectric substantially disposed between the medial inner portion and the medial outer portion, and defined in the medial inner portion is a plurality of divaricated cuts.

According to yet another aspect, a connector system includes a housing and at least one compressible electrical assembly disposed in the housing. The at least one compressible electrical assembly includes an inner compressible contact, having a first inner contact end, a second inner contact end opposing the first inner contact end, and a medial inner portion positioned between the first inner contact end and the second inner contact end; an outer compressible contact, comprising a first outer contact end, a second outer contact end opposing the first outer contact end, and a medial outer portion positioned between the first outer contact end and the second outer contact end; and a dielectric substantially disposed between the medial inner portion and the medial outer portion. Moreover, defined in each of the first inner contact end, the second inner contact end, the first outer contact end, and the second outer contact end is a plurality of divaricated cuts. The system additionally includes at least one printed circuit board coupled to the at least one compressible electrical assembly.

Additional aspects of the embodiments disclosed herein will be apparent upon review of the drawings and description, which follow.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1A is an isometric view of a compressible electrical assembly in accordance with embodiments disclosed herein;

FIG. 1B is a front view of the compressible electrical assembly shown in FIG. 1A;

FIG. 1C is a cross-sectional view of the compressible electrical assembly, shown in FIG. 1A;

FIG. 1D is a cross-sectional view of a system, including two compressible electrical assemblies, assembled with a housing, center contacts, a printed circuit boards;

FIG. 2A is an isometric view of another compressible electrical assembly in accordance with embodiments disclosed herein;

FIG. 2B is a front view of the compressible electrical assembly shown in FIG. 2A;

FIG. 2C is a cross-sectional view of the compressible electrical assembly shown in FIG. 2A;

FIG. 3A is an isometric view of another compressible electrical assembly in accordance with embodiments disclosed herein;

FIG. 3B is a front view of the compressible electrical assembly shown in FIG. 3A;

FIG. 3C is a cross-sectional view of the compressible electrical assembly shown in FIG. 3A;

FIG. 4A is an isometric view of another compressible electrical assembly in accordance with embodiments disclosed herein;

FIG. 4B is a front view of the compressible electrical assembly shown in FIG. 4A;

FIG. 4C is a cross-sectional view of the compressible electrical assembly shown in FIG. 4A;

FIG. 5A is an isometric view of another compressible electrical assembly in accordance with embodiments disclosed herein;

FIG. 5B is a front view of the compressible electrical assembly shown in FIG. 5A;

FIG. 5C is a cross-sectional view of the compressible electrical assembly, shown in FIG. 5A;

FIG. 5D is a cross-sectional view a connector system, including printed circuit boards, center contacts, housings, and the compressible electrical assembly shown in FIGS. 5A-5C;

FIG. 6A is an isometric view of another compressible electrical assembly in accordance with embodiments disclosed herein;

FIG. 6B is a front view of the compressible electrical assembly shown in FIG. 6A;

FIG. 6C is a cross-sectional view of the compressible electrical assembly shown in FIG. 6A;

FIG. 6D is a cross-sectional view an assembly, including printed circuit boards, center contacts, housings, and the compressible electrical assembly shown in FIGS. 6A-6C;

FIG. 7A is an isometric view of a housing and center contact assembly in accordance with embodiment disclosed herein;

FIG. 7B is a front view of the housing and center contact assembly shown in FIG. 7A;

FIG. 7C is a cross-sectional view of the housing and center contact assembly shown in FIG. 7A.

FIG. 8A is another isometric view of a compressible electrical assembly in accordance with embodiments disclosed herein;

FIG. 8B is a front view of the compressible electrical assembly, shown in FIG. 8A;

FIG. 8C is a cross-sectional view of the compressible electrical assembly shown in FIG. 8A;

FIG. 8D is a cross-section view of a connector system, including the housing and center contact assembly, shown in FIGS. 8A-8C, printed circuit boards, and a compressible electrical contact;

FIG. 9A is an isometric view of a housing and center contact assembly in accordance with embodiments disclosed herein;

FIG. 9B is a front view of the housing and center contact assembly, shown in FIG. 9A;

FIG. 9C is a cross-sectional view of the housing and center contact assembly shown in FIG. 9A;

FIG. 10A is an isometric view of a housing and center contact assembly in accordance with embodiment disclosed herein;

FIG. 10B is a front view of the housing and center contact assembly shown in FIG. 10A; and

FIG. 10C is a cross-sectional view of the housing and center contact assembly shown in FIG. 10A.

The figures are not necessarily to scale. Like numbers used in the figures may be used to refer to like components. However, it will be understood that the use of a number to refer to a component in a given figure is not intended to limit the component in another figure labeled with the same number.

### DETAILED DESCRIPTION

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not limited to the described exemplary embodiments, but are to be controlled by the limitations set forth in the claims and any equivalents thereof.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

Cartesian coordinates are used in some of the Figures for reference and are not intended to be limiting as to direction or orientation.

For purposes of description herein, the terms “upper,” “lower,” “right,” “left,” “rear,” “front,” “vertical,” “horizontal,” “top,” “bottom,” “side,” and derivatives thereof, shall relate to the disclosure as oriented with respect to the Cartesian coordinates in the corresponding Figure, unless stated otherwise. However, it is to be understood that the disclosure may assume various alternative orientations, except where expressly specified to the contrary.

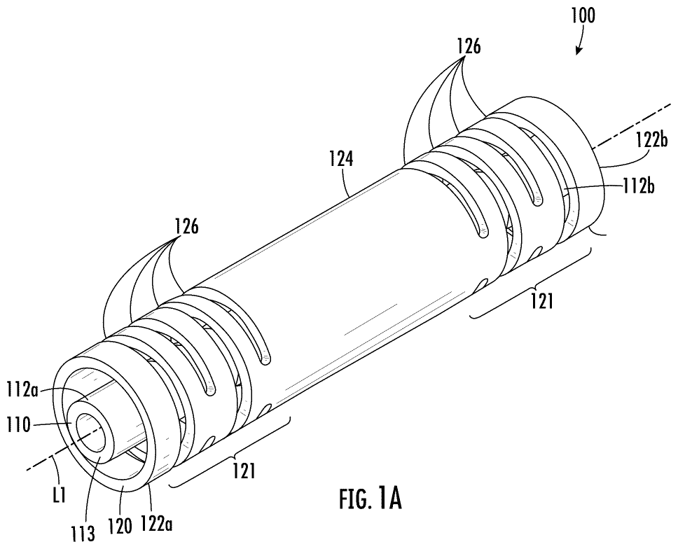

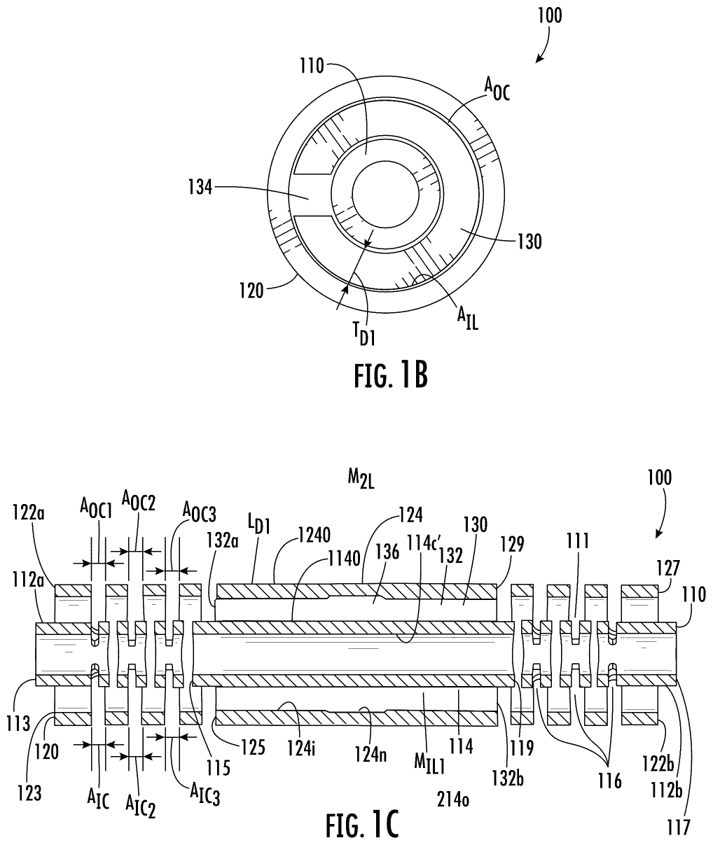

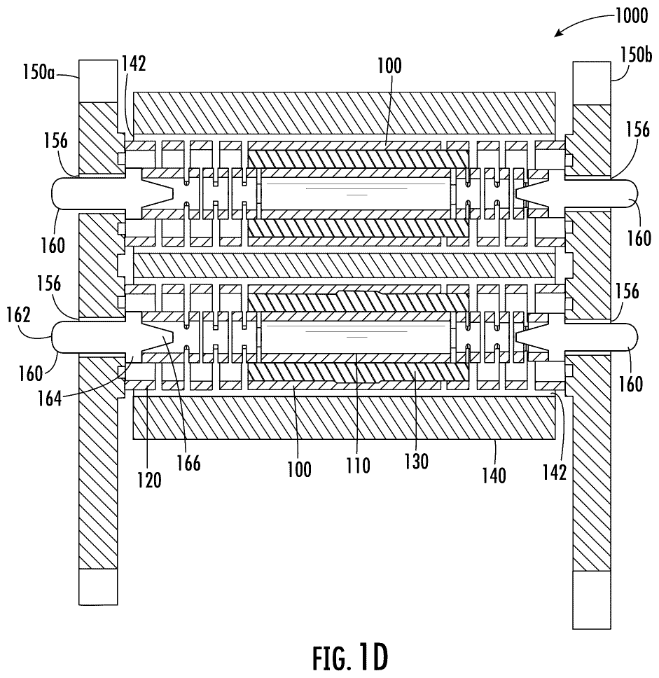

FIGS. 1A-1C illustrate a compressible electrical assembly 100, including an inner compressible contact 110, an outer compressible contact 120, and a dielectric 130. Both the inner compressible contact 110 and the outer compressible contact 120 are shown in a substantially relaxed state, with the dielectric 130 disposed therebetween. Each element, as shown in the assembly, is shown arranged with respect to a common longitudinal axis L1.

All the compressible electrical contacts disclosed herein are preferably manufactured from tubes using one or more precision cutting methods, e.g. laser cutting. The tube is also preferably manufactured from one or more electrically conductive materials. Suitable materials for the compressible electrical contact include, but are not limited to, brass, copper, beryllium copper and stainless steel. Preferably, these materials have spring-like properties, high strength, high elastic limit, and low moduli.

Overall dimensions for the compressible electrical contacts disclosed herein can range from micro- to large scale. Targeted sizes, however, are on a smaller basis given current industry trends. An exemplary tube size has an inner diameter of about 0.006 inches, an outer diameter of about 0.010 inches, and an overall length of about 0.070 inches. When the compressible electrical contact is manufactured, using a tube having these dimensions, the resulting cut angles range from about 1.5 to about 5 degrees.

Dimensions of the compressible electrical contacts disclosed herein, however, depend on various factors, including but not limited to application requirement, the contact's spring rate and the length of travel between a substantially relaxed state and a compressed state. In some configurations, the compressible electrical contacts can have an effective inner diameter of about 0.006 inches, an effective outer diameter of about 0.010 inches, and an overall length of about 0.070 inches, when manufactured from a tube having an inner diameter of about 0.006 inches, an outer diameter of about 0.010 inches, and an overall length of about 0.070 inches.

In the first embodiment of the compressible electrical assembly 100, the inner compressible contact 110 includes a first inner contact end 112a, a second inner contact end 112b opposing the inner contact end, and a medial inner portion 114 positioned between the first inner contact end 112a and the second inner contact end 112b. The first inner contact end 112a extends from an outermost face 113 to an inner face 115 of the first inner contact end 112a. The second inner contact end 112b extends from an outermost face 117 to an inner face 119 of the second inner contact end 112b.

Defined in each inner contact end 112a, 112b is a divaricated-cut section 111, having a plurality of divaricated cuts 116. In this version of the inner compressible contact 110, three divaricated cuts are shown are shown in each contact end. However, additional divaricated cuts may be included, depending on application requirements. Each divaricated cut in the inner compressible contact 110 is defined by at least one cut angle A_{CI}n, where n equals the number of divaricated cuts and where the angle is measured from opposing inner surfaces of each respective divaricated cut. In this configuration, three cut are shown A_{CI1}, A_{CI2}, A_{CI3} are shown. When collapsed, the opposing inner surfaces form a slot.

The medial inner portion 114 is tubular, divaricated-cut free, defined by an inner diameter 114i and outer diameter 114o and a medial inner portion length, M_{IL}, measured between inner faces 115, 119. The medial outer portion 124 also includes a radially disposed notch 124n.

The outer compressible contact 120 includes a first outer contact end 122a, a second outer contact end 122b opposing the outer contact end, and a medial outer portion 124 positioned between the first outer contact end 122a and the second outer contact end 122b. The first outer contact end 122a extends from an outermost face 123 to an inner face 125 of the first outer contact end 122a. The second outer contact end 122b extends from an outermost face 127 to an inner face 129 of the second outer contact end 122b. Notably, the first inner contact end 112a and the second inner contact end 112b extend beyond the first outer contact end 122a and the second outer contact end 122b.

Defined in each inner contact end 122a, 122b is a divaricated-cut section 121, having a plurality of divaricated cuts 126. In this version of the outer compressible contact 120, at least three divaricated cuts are shown are shown in each contact end. However, additional divaricated cuts may be included, depending on application requirements.

Each divaricated cut in the inner compressible contacts disclosed herein can be defined by at least one cut angle A_{CO}n, where n equals the number of divaricated cuts and where the angle is measured from opposing inner surfaces of each respective divaricated cut. In this compressible contact configuration, three cuts A_{CO1}, A_{CO2}, A_{CO3} are shown.

The medial inner portion 124 is tubular, divaricated-cut free, defined by an inner diameter 124i and outer diameter 124o and a medial inner portion length, M_{OL}, measured between inner faces 125, 129. The medial outer portion 124 also includes a radially disposed notch 124n.

In the compressible electrical assembly 100, the dielectric 130 is positioned between the inner compressible contact 110 and the outer compressible contact 120, as shown particularly in FIGS. 1B and 1C. The dielectric 130 has a dielectric body 132, with a first body end 132a and a second body end 132b opposing the first body end 132a. Defined in this configuration of the dielectric is a channel 134. Preferably, the channel 134 extends fully along the length LD1 of the dielectric 130. The dielectric 130 is further defined by an inner arc length A_{IL}, an outer arc length A_{IL}, and a dielectric thickness T_{D1}. In addition, the dielectric has a centrally located upwardly extending portion 136 that fits within notch 124n.

FIG. 1D shows an exemplary connector system 1000, which includes two compressible electrical assemblies 100, a housing 140, printed circuit boards 150a, 150b, and contacts 160a, 160b.

The housing 140 helps to align the respective compressible electrical assembly 100 for signal transmission. Defined in the housing 140 are two thru-holes 142. Each thru-hole 142 is configured to house the compressible electrical assembly 100, including the inner compressible contact 110, the outer compressible contact 120, and the dielectric 130. This configuration of the housing 140 may also be suited for other compressible electrical assembly configurations, which will be further described herein.

Each printed circuit board 150a, 150b includes a base 152 and a plurality of engagement elements 154 that couple with the compressible electrical assembly 100. Also, each printed circuit board has at least two apertures 156 for positioning of contacts therein.

Each contact 160 has a male configuration and is soldered or otherwise attached to the printed circuit boards. Each contact 160a, 160b preferably includes a rounded portion 162, a medial portion 164, and a tapered portion 166. The overall contact configuration ensures concentricity within the connector system and alignment with the printed circuit boards 150a, 150b and the compressible electrical assembly 100. Each rounded portion 162 is configured for positioning in apertures 156.

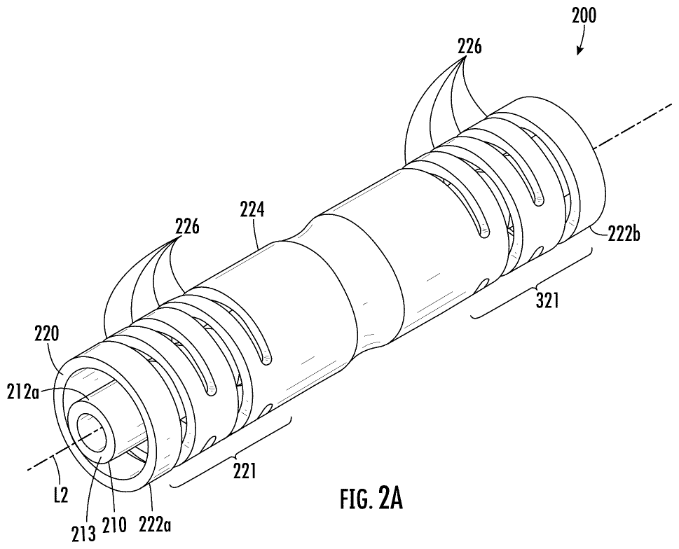

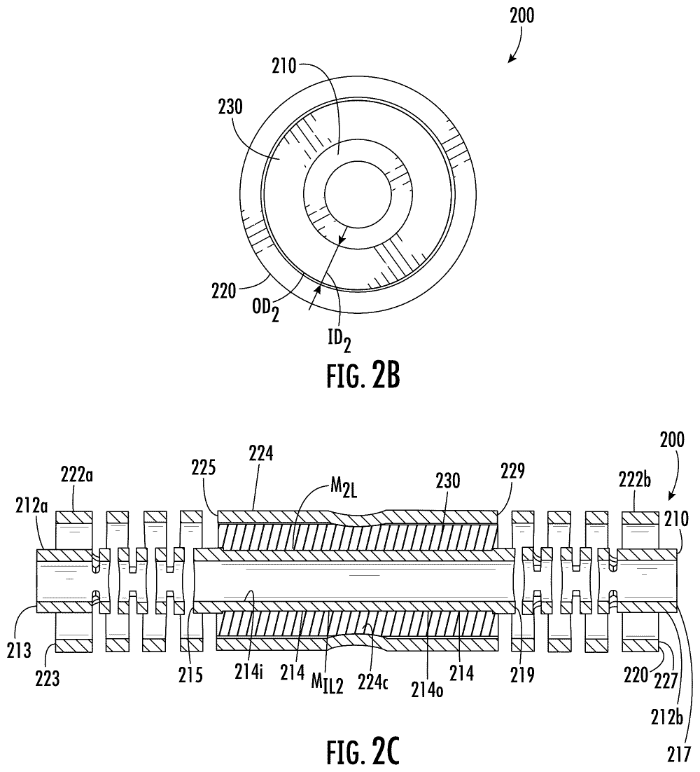

FIGS. 2A-2C illustrate another compressible electrical assembly 200, including an inner compressible contact 210, an outer compressible contact 220, and a dielectric 230. Both the inner compressible contact 210 and the outer compressible contact 220 are shown in a substantially relaxed state, with the dielectric 230 disposed therebetween. Each element, as shown in the assembly, is shown arranged with respect to a common longitudinal axis L2.

The inner compressible contact 210 includes a first inner contact end 212a, a second inner contact end 212b opposing the inner contact end, and a medial inner portion 214 positioned between the first inner contact end 212a and the second inner contact end 212b. The first inner contact end 212a extends from an outermost face 213 to an inner face 215 of the first inner contact end 212a. The second inner contact end 212b extends from an outermost face 217 to an inner face 219 of the second inner contact end 212b. The medial inner portion 214 includes a radially disposed crimped area 218 centrally positioned along the length of the medial outer portion 214.

Defined in each inner contact end 212a, 212b is a divaricated cut section 211 having a plurality of divaricated cuts 216. In this version of the inner compressible contact 210, at least three divaricated cuts are shown are shown in each contact end. However, additional divaricated cuts may be included, depending on application requirements.

The medial inner portion 214 is tubular, divaricated-cut free, defined by an inner diameter 214i and outer diameter 114o and a medial inner portion length, M_{2L}, measured between inner faces 215, 219. The medial outer portion 224 also conforms to the radially disposed crimp area 218 to form a crimped portion 224c.

The outer compressible contact 220 includes a first inner contact end 222a, a second inner contact end 222b opposing the inner contact end, and a medial outer portion 224 positioned between the first outer contact end 222a and the second outer contact end 222b. The first outer contact end 222a extends from an outermost face 223 to an inner face 225 of the first inner contact end 222a. The second inner contact end 222b extends from an outermost face 227 to an inner face 229 of the second outer contact end 222b.

Defined in each inner contact end 222a, 222b is a plurality of divaricated cuts 226. In this version of the outer compressible contact 220, three divaricated cuts are shown are shown in each contact end. However, additional divaricated cuts may be included, depending on application requirements. Each divaricated cut in the inner compressible contact 220 is defined by at least one cut angle A_{CO}n, where n equals the number of divaricated cuts and where the angle is measured from opposing inner surfaces of each respective divaricated cut. In this configuration, three cut are shown A_{CO1}, A_{CO2}, A_{CO3} are shown.

The medial inner portion 224 is tubular, divaricated-cut free, defined by an inner diameter 224i and outer diameter 224o and a medial inner portion length, M_{OL}, measured between inner faces 225, 229. The medial outer portion 224 also includes a radially disposed notch 224n.

In the compressible electrical assembly 200, the dielectric 230 is positioned between the inner compressible contact 210 and the outer compressible contact 220, as shown particularly in FIGS. 2B and 2C. The dielectric 230 has a dielectric body 232, with a first body end 232a and a second body end 232b opposing the first body end 232a. The dielectric 130 is further defined by an inner diameter ID₂ an outer diameter OD₂, and a dielectric thickness T_{D2}.

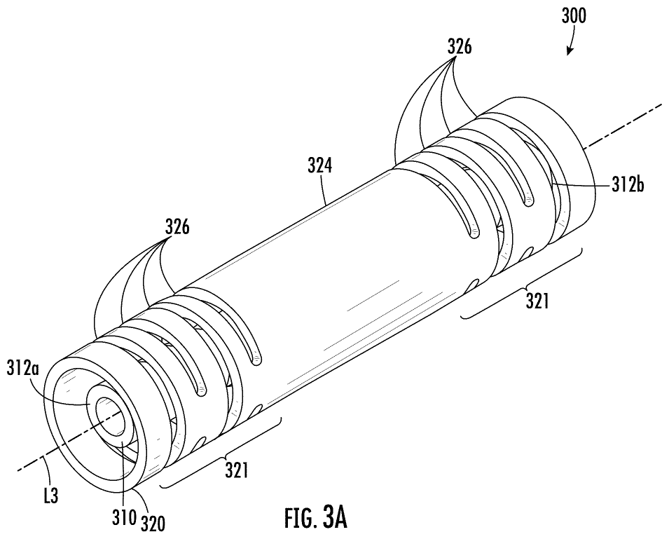

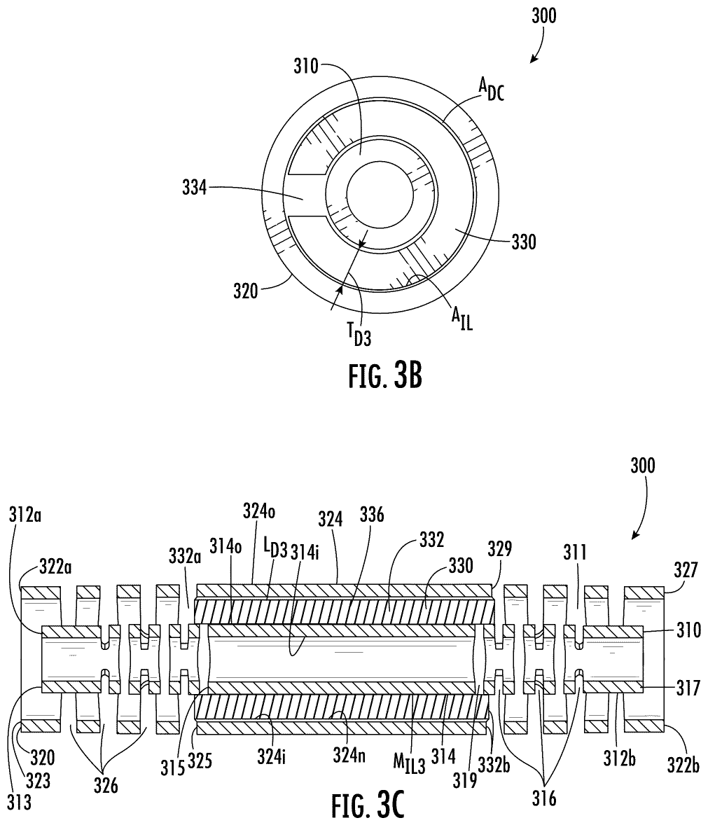

FIGS. 3A-3C illustrate another embodiment of a compressible electrical assembly 300, including an inner compressible contact 310, an outer compressible contact 320, and a dielectric 330. Both the inner compressible contact 310 and the outer compressible contact 320 are shown in a substantially relaxed state, with the dielectric 330 disposed therebetween. Each element, as shown in the assembly, is shown arranged with respect to a common longitudinal axis L3.

In this embodiment of the compressible electrical assembly 300, the inner compressible contact 310 includes a first inner contact end 312a, a second inner contact end 312b opposing the inner contact end, and a medial inner portion 314 positioned between the first inner contact end 312a and the second inner contact end 312b. The first inner contact end 312a extends from an outermost face 313 to an inner face 315 of the first inner contact end 312a. The second inner contact end 312b extends from an outermost face 317 to an inner face 319 of the second inner contact end 312b.

Defined in each inner contact end 312a, 312b is a divaricated-cut section 311, having a plurality of divaricated cuts 316. In this version of the inner compressible contact 310, three divaricated cuts are shown are shown in each contact end. However, additional divaricated cuts may be included, depending on application requirements. Each divaricated cut in the inner compressible contact 310 is defined by at least one cut angle A_{CI}n, where n equals the number of divaricated cuts and where the angle is measured from opposing inner surfaces of each respective divaricated cut. In this configuration, three cut are shown A_{CI3}, A_{CI2}, A_{CI3} are shown.

The medial inner portion 314 is tubular, divaricated-cut free, defined by an inner diameter 314i and outer diameter 314o and a medial inner portion length, M_{IL}, measured between inner faces 315, 319. The medial outer portion 324 also includes a radially disposed notch 324n.

The outer compressible contact 320 includes a first outer contact end 322a, a second outer contact end 322b opposing the outer contact end, and a medial outer portion 324 positioned between the first outer contact end 322a and the second outer contact end 322b. The first outer contact end 322a extends from an outermost face 323 to an inner face 325 of the first outer contact end 322a. The second outer contact end 322b extends from an outermost face 327 to an inner face 329 of the second outer contact end 322b. Notably, the first outer contact end 322a and the second outer contact end 322b extend beyond the first outer contact end 312a and the second outer contact end 312b.

Defined in each inner contact end 322a, 322b is a divaricated-cut section 321, having a plurality of divaricated cuts 326. In this version of the outer compressible contact 320, at least three divaricated cuts are shown are shown in each contact end. However, additional divaricated cuts may be included, depending on application requirements.

The medial inner portion 324 is tubular, divaricated-cut free, defined by an inner diameter 324i and outer diameter 324o and a medial inner portion length, M_{OL}, measured between inner faces 325, 329. The medial outer portion 324 also includes a radially disposed notch 324n.

In the compressible electrical assembly 300, the dielectric 330 is positioned between the inner compressible contact 310 and the outer compressible contact 320, as shown particularly in FIGS. 3B and 3C. The dielectric 330 has a dielectric body 332, with a first body end 332a and a second body end 332b opposing the first body end 332a. Defined in this configuration of the dielectric is a channel 334. Preferably, the channel 334 extends fully along the length LD3 of the dielectric 330. The dielectric 330 is further defined by an inner arc length A_{IL}, an outer arc length A_{IL}, and a dielectric thickness T_{D3}. In addition, the dielectric has a centrally located upwardly extending portion 336 that fits within notch 324n.

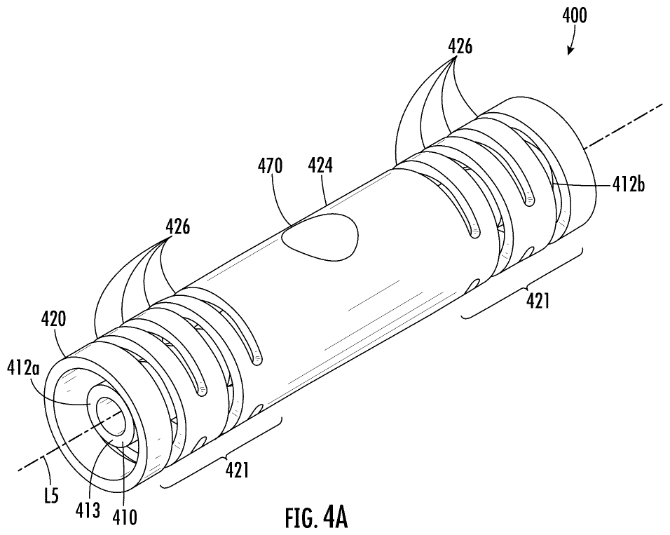

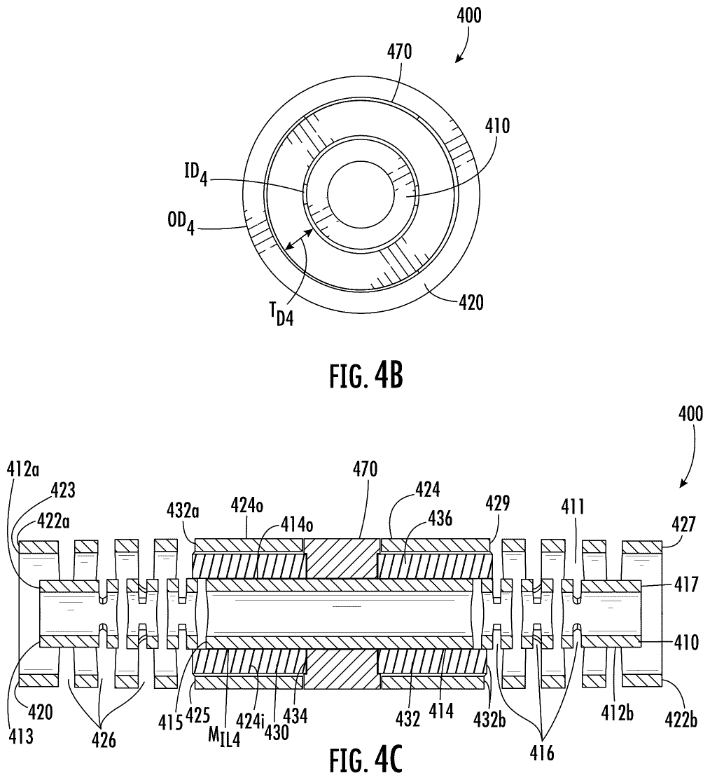

FIGS. 4A-4C illustrate another embodiment of a compressible electrical assembly 400, including an inner compressible contact 410, an outer compressible contact 420, and a dielectric 430. Both the inner compressible contact 410 and the outer compressible contact 420 are shown in a substantially relaxed state, with the dielectric 430 disposed therebetween. Each element, as shown in the assembly, is shown arranged with respect to a common longitudinal axis L4.

Referring particularly to FIG. 4C, in this embodiment of the compressible electrical assembly 400, the inner compressible contact 410 includes a first inner contact end 412a, a second inner contact end 412b opposing the inner contact end, and a medial inner portion 414 positioned between the first inner contact end 412a and the second inner contact end 412b. The first inner contact end 412a extends from an outermost face 413 to an inner face 415 of the first inner contact end 412a. The second inner contact end 412b extends from an outermost face 417 to an inner face 419 of the second inner contact end 412b.

Defined in each inner contact end 412a, 412b is a divaricated-cut section 411, having a plurality of divaricated cuts 416. In this version of the inner compressible contact 410, three divaricated cuts are shown are shown in each contact end. However, additional divaricated cuts may be included, depending on application requirements. Each divaricated cut in the inner compressible contact 410 is defined by at least one cut angle A_{CI}n, where n equals the number of divaricated cuts and where the angle is measured from opposing inner surfaces of each respective divaricated cut.

The medial inner portion 414 is tubular, divaricated-cut free, defined by an inner diameter 414i and outer diameter 414o and a medial inner portion length, M_{IL}, measured between inner faces 415, 419. The medial outer portion 424 also includes a radially and centrally positioned opening 470. Disposed within the opening 470 is a retaining element 480, which is preferably curable and configured to retain the center contact and dielectric in the assembly 400. The retaining element 470 may be an adhesive, an epoxy-based material or the like, which can be used for retention purposes.

The outer compressible contact 420 includes a first outer contact end 422a, a second outer contact end 422b opposing the outer contact end, and a medial outer portion 424 positioned between the first outer contact end 422a and the second outer contact end 422b. The first outer contact end 422a extends from an outermost face 423 to an inner face 425 of the first outer contact end 422a. The second outer contact end 422b extends from an outermost face 427 to an inner face 429 of the second outer contact end 422b. Notably, the first outer contact end 422a and the second outer contact end 422b extend beyond the first inner contact end 412a and the second inner contact end 412b.

Defined in each inner contact end 422a, 422b is a divaricated-cut section 421, having a plurality of divaricated cuts 426. In this version of the outer compressible contact 420, at least three divaricated cuts are shown are shown in each contact end. However, additional divaricated cuts may be included, depending on application requirements.

The medial inner portion 424 is tubular, divaricated-cut free, defined by an inner diameter 424i and outer diameter 424o and a medial inner portion length, M_{OL}, measured between inner faces 425, 429. The medial outer portion 424 also includes a radially disposed notch 424n.

In the compressible electrical assembly 400, the dielectric 430 is positioned between the inner compressible contact 410 and the outer compressible contact 420, as shown particularly in FIGS. 4B and 4C. The dielectric 430 has a dielectric body 432, with a first body end 432a and a second body end 432b opposing the first body end 432a. Defined in this configuration of the dielectric is a channel 434. Preferably, the channel 434 extends fully through the dielectric 430, as shown in FIG. 4C. The dielectric 130 is further defined by an inner diameter ID₄ an outer diameter OD₄, and a dielectric thickness T_{D4}.

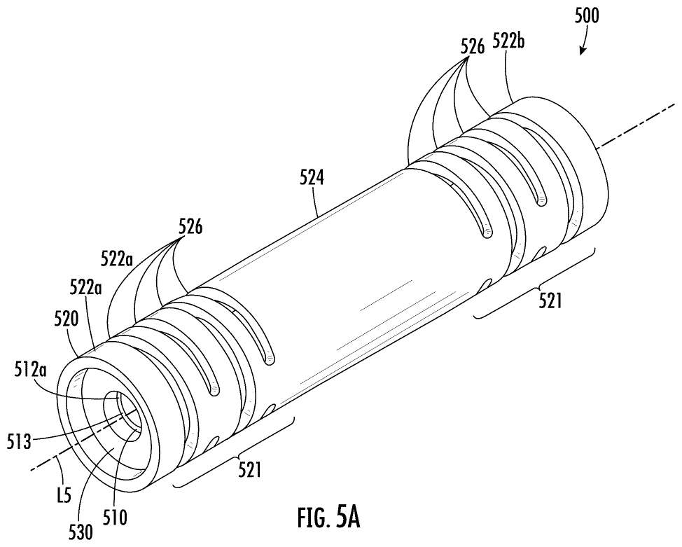

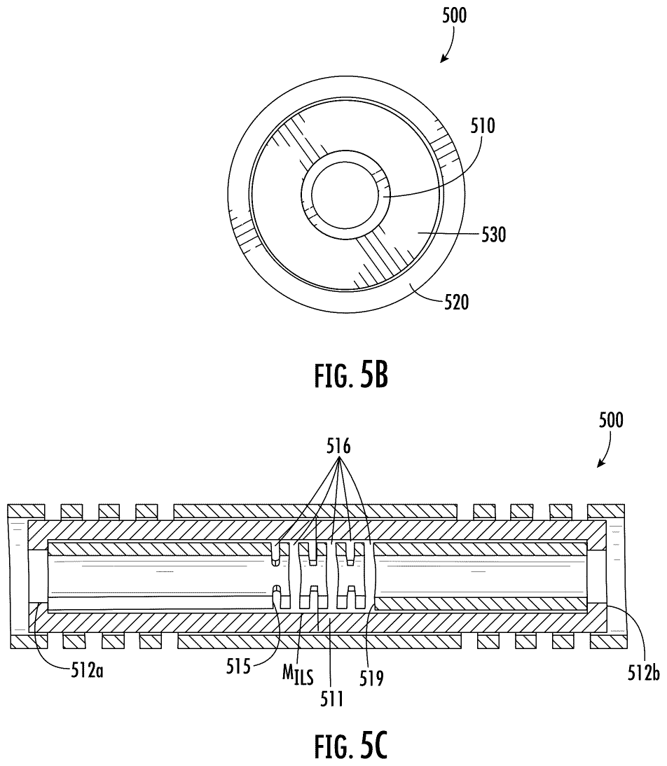

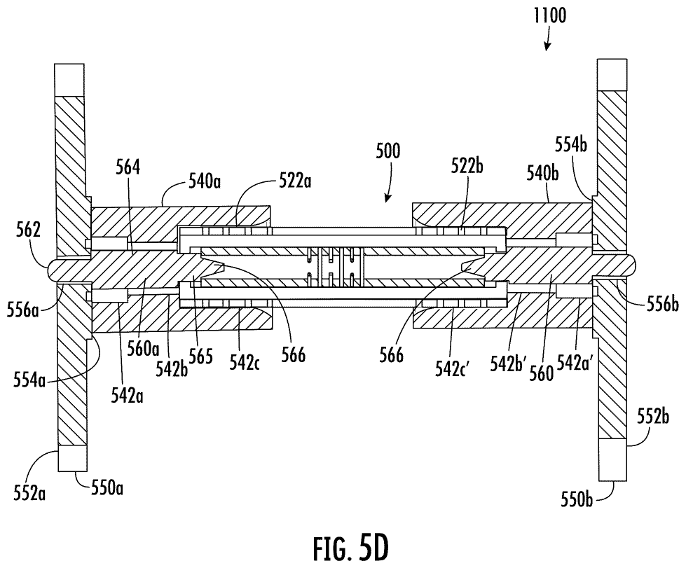

FIGS. 5A-5C illustrate another embodiment of a compressible electrical assembly 500, including an inner compressible contact 510, an outer compressible contact 520, and a dielectric 530. Both the inner compressible contact 510 and the outer compressible contact 520 are shown in a substantially relaxed state, with the dielectric 530 disposed therebetween. Each element, as shown in the assembly, is shown arranged with respect to a common longitudinal axis L5.

Referring particularly to FIG. 5C, in this embodiment of the compressible electrical assembly 500, the inner compressible contact 510 includes a first inner contact end 512a, a second inner contact end 512b opposing the inner contact end, and a medial inner portion 514 positioned between the first inner contact end 512a and the second inner contact end 512b. The first inner contact end 512a extends from an outermost face 513 to an inner face 515 of the first inner contact end 512a. The second inner contact end 512b extends from an outermost face 517 to an inner face 519 of the second inner contact end 512b.

Defined in each inner contact end 512a, 512b is a divaricated-cut section 511, having a plurality of divaricated cuts 516. In this version of the inner compressible contact 510, three divaricated cuts are shown are shown in each contact end. However, additional divaricated cuts may be included, depending on application requirements. Each divaricated cut in the inner compressible contact 510 is defined by at least one cut angle A_{CI}n, where n equals the number of divaricated cuts and where the angle is measured from opposing inner surfaces of each respective divaricated cut.

The medial inner portion 514 includes a divaricated cut section 511 with a plurality of divaricated cuts 516 and is also a medial inner portion length, M_{IL5}, measured between inner faces 515, 519.

The outer compressible contact 520 includes a first outer contact end 522a, a second outer contact end 522b opposing the outer contact end, and a medial outer portion 524 positioned between the first outer contact end 522a and the second outer contact end 522b. The first outer contact end 522a extends from an outermost face 523 to an inner face 525 of the first outer contact end 522a. The second outer contact end 522b extends from an outermost face 527 to an inner face 529 of the second outer contact end 522b. Notably, the first outer contact end 522a and the second outer contact end 522b extend beyond the first inner contact end 512a and the second inner contact end 512b.

Defined in each inner contact end 522a, 522b is a divaricated-cut section 521, having a plurality of divaricated cuts 526. In this version of the outer compressible contact 520, at least three divaricated cuts are shown are shown in each contact end. However, additional divaricated cuts may be included, depending on application requirements.

The medial inner portion 524 is tubular, divaricated-cut free, defined by an inner diameter 524i and outer diameter 524o and a medial inner portion length, M_{OL}, measured between inner faces 525, 529.

In the compressible electrical assembly 500, the dielectric 530 is positioned between the inner compressible contact 510 and the outer compressible contact 520, as shown particularly in FIGS. 5B and 5C. The dielectric 530 has a dielectric body 532, with a first body end 532a and a second body end 532b opposing the first body end 532a. Defined in this configuration of the dielectric is a channel 534. Preferably, the channel 534 extends fully through the dielectric 530, as shown in FIG. 5C. The dielectric 130 is further defined by an inner diameter ID₅ an outer diameter OD₅, and a dielectric thickness TD₅.

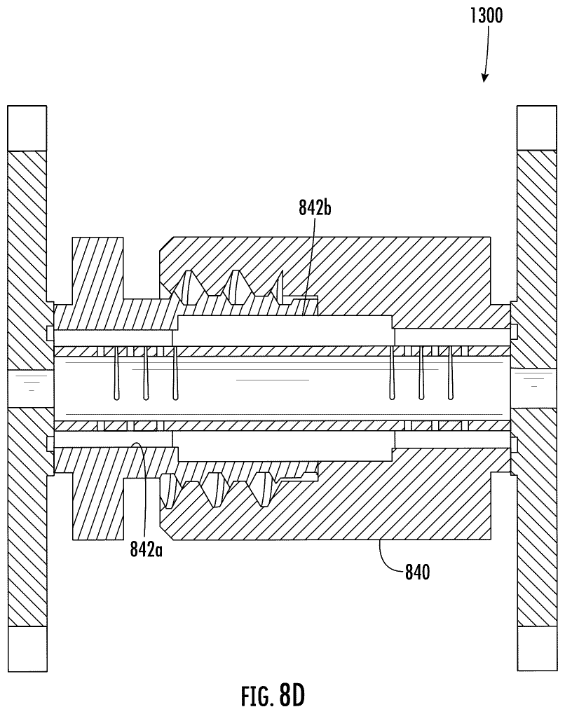

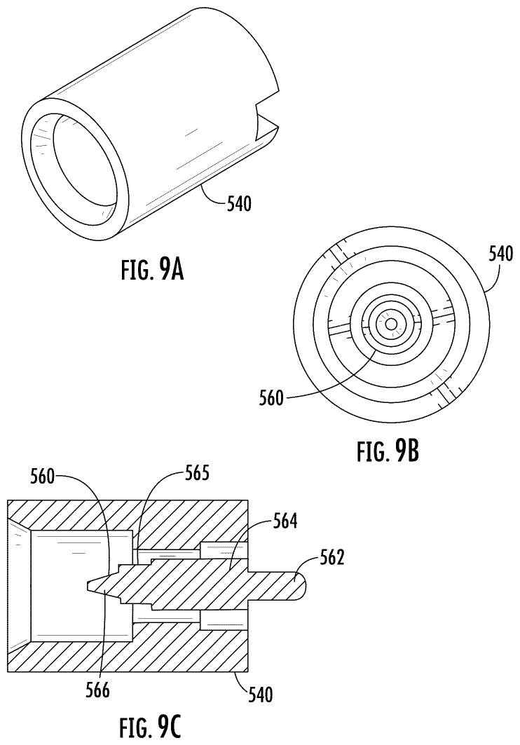

FIG. 5D shows an exemplary connector system 1100, which includes the compressible electrical assembly 500, housings 540a, 540b, printed circuit boards 550a, 550b, and contacts 560a, 560b. FIGS. 9A-9C show additional views of the housings 540 assembled with contacts 560.

Each housing 540a, 540b helps to align the compressible electrical assembly 500 for signal transmission. Defined in the housing 540 are bores 542a, 542b, 542c, 542a′, 542b′, 542c′. Bores 542c, 542c′ also have chamfers 543, 543′ that facilitate insertion of the contact ends 522a, 522b into the housings.

Each printed circuit board 550a, 550b includes a base 552a, 552b and an engagement element 554a, 554b that couple with the compressible electrical assembly 500. Also, each printed circuit board has at least one aperture 556a, 556b for positioning of contacts therein.

Each contact 560 has a male configuration and is soldered or otherwise attached to the printed circuit boards. Each contact 560a, 560b preferably includes a rounded portion 562, medial contact portions 564, 565, and a tapered portion 566. The overall contact configuration ensures concentricity within the connector system and alignment with the printed circuit boards 550a, 550b and the compressible electrical assembly 500. Each rounded portion 562 is configured for positioning in apertures 556a, 556b.

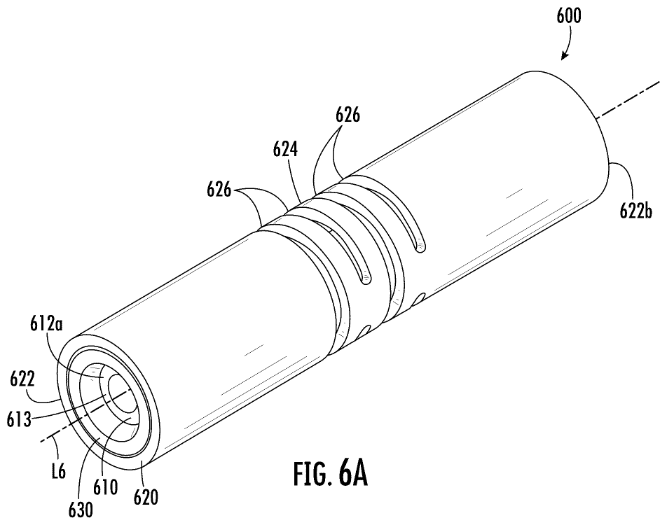

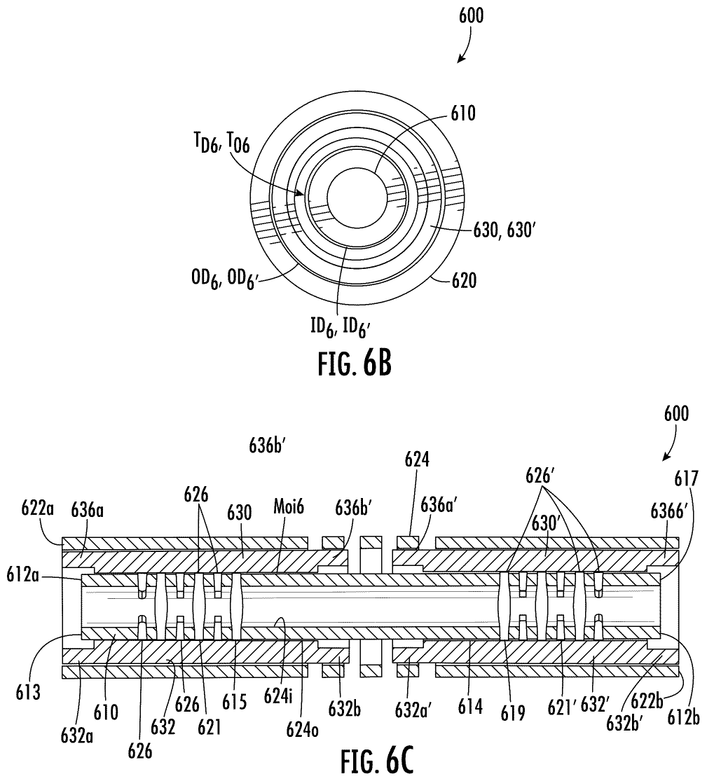

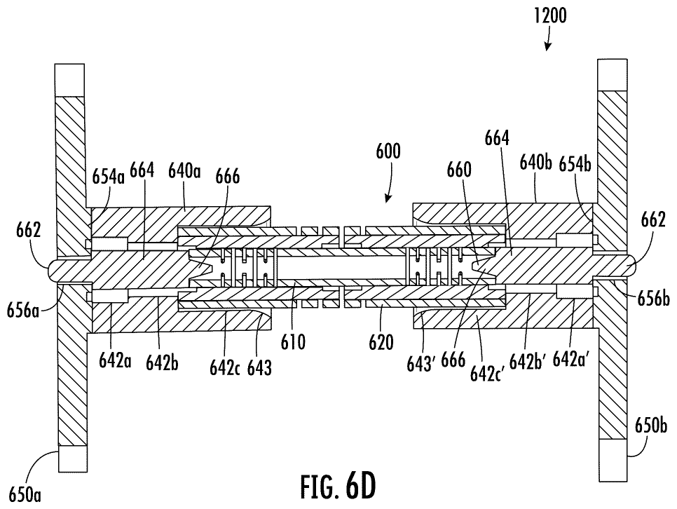

FIGS. 6A-6C illustrate another embodiment of a compressible electrical assembly 600, including an inner compressible contact 610, an outer compressible contact 620, and a dielectric 630. Both the inner compressible contact 610 and the outer compressible contact 620 are shown in a substantially relaxed state, with the dielectric 630 disposed therebetween. Each element, as shown in the assembly, is shown arranged with respect to a common longitudinal axis L6.

Referring particularly to FIG. 6C, in this embodiment of the compressible electrical assembly 600, the inner compressible contact 610 includes a first inner contact end 612a, a second inner contact end 612b opposing the inner contact end, and a medial inner portion 614 positioned between the first inner contact end 612a and the second inner contact end 612b. The first inner contact end 612a extends from an outermost face 613 to an inner face 615. The second inner contact end 612b extends from an outermost face 617 to an inner face 619 of the second inner contact end 612b.

The outer compressible contact 620 includes a first outer contact end 622a, a second outer contact end 622b opposing the outer contact end, and a medial outer portion 624 positioned between the first outer contact end 622a and the second outer contact end 622b. The first outer contact end 622a extends from an outermost face 623 to an inner face 625 of the first outer contact end 622a. The second outer contact end 622b extends from an outermost face 627 to an inner face 629 of the second outer contact end 622b. Notably, the first outer contact end 622a and the second outer contact end 622b extend beyond the first outer inner end 612a and the second inner contact end 612b.

The medial inner portion 614 includes a divaricated cut section 611 with a plurality of divaricated cuts 616 and is also defined by a medial inner portion length, M_{IL6}, measured between inner faces 615, 619. Each divaricated cut in the inner compressible contact 610 is defined by at least one cut angle, as described with respect to FIGS. 1A-1C.

Defined in each inner contact end 622a, 622b is a divaricated-cut section 621, 621′ having a plurality of divaricated cuts 626, 626′. In this version of the outer compressible contact 620, at least three divaricated cuts are shown are shown in each contact end. However, additional divaricated cuts may be included, depending on application requirements.

The medial inner portion 624 is tubular, divaricated-cut free, defined by an inner diameter 624i and outer diameter 624o and a medial inner portion length, M_{OL6}, measured between inner faces 625, 629.

In the compressible electrical assembly 600, two dielectrics 630, 630′ are positioned between the inner compressible contact 610 and the outer compressible contact 620, as shown particularly in FIGS. 6B and 6C. Each dielectric 630, 630′ has a dielectric body 632, 632′ with a first body end 632a, 632a′ and a second body end 632b, 632b′ opposing the first body end 632a, 632a′. In this configuration, each dielectric has two overhang portion 636a, 636a′. 626b, 636b′. Each dielectric 630, 630′ is also defined by an inner diameter ID₆, ID_{6′} an outer diameter OD₆, OD_{6′} and a dielectric thickness T_{D6}, T_{D6′}.

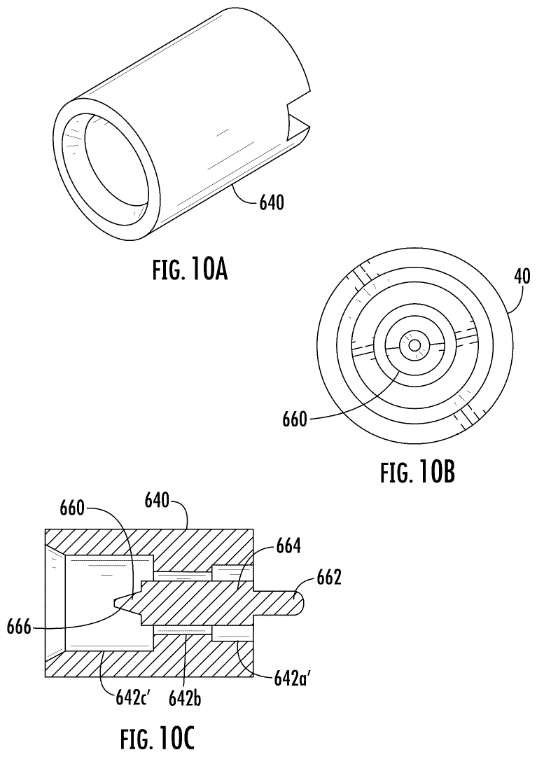

FIG. 6D shows an exemplary connector system 1200, which includes the compressible electrical assembly 600, housings 640a, 640b, printed circuit boards 650a, 650b, and contacts 660a, 660b. FIGS. 10A-10C show additional views of the housings 640 assembled with contacts 660.

Each housing 640a, 640b helps to align the compressible electrical assembly 600 for signal transmission. Defined in the housing 640 are bores 642a, 642b, 642c, 642a′, 642b′, 642c′. Bores 642c, 642c′ also have chamfers 643, 643′ that facilitate insertion of the contact ends 622a, 622b into the housings.

Each printed circuit board 650a, 650b includes a base 652a, 652b and an engagement element 654a, 654b that couple with the compressible electrical assembly 600. Also, each printed circuit board has at least one aperture 656a, 656b for positioning of contacts therein.

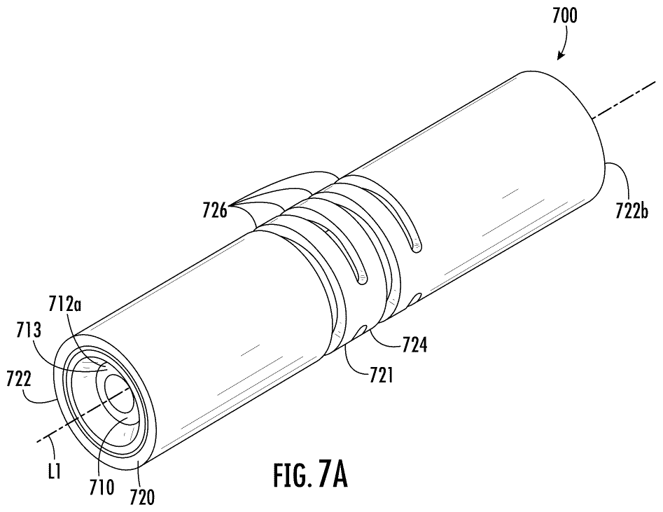

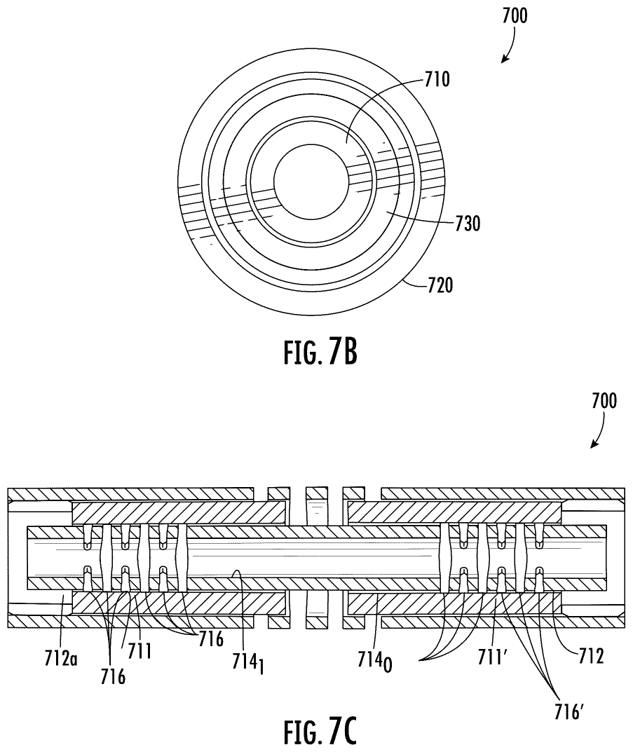

FIGS. 7A-7C illustrate another embodiment of a compressible electrical assembly 700, including an inner compressible contact 710, an outer compressible contact 720, and a dielectric 730. Both the inner compressible contact 710 and the outer compressible contact 720 are shown in a substantially relaxed state, with the dielectric 730 disposed therebetween. Each element, as shown in the assembly, is shown arranged with respect to a common longitudinal axis L7.

Referring particularly to FIG. 7C, in this embodiment of the compressible electrical assembly 700, the inner compressible contact 710 includes a first inner contact end 712a, a second inner contact end 712b opposing the inner contact end, and a medial inner portion 714 positioned between the first inner contact end 712a and the second inner contact end 712b. The first inner contact end 712a extends from an outermost face 713 to an inner face 715. The second inner contact end 712b extends from an outermost face 717 to an inner face 719 of the second inner contact end 712b.

The outer compressible contact 720 includes a first outer contact end 722a, a second outer contact end 722b opposing the outer contact end, and a medial outer portion 724 positioned between the first outer contact end 722a and the second outer contact end 722b. The first outer contact end 722a extends from an outermost face 723 to an inner face 725 of the first outer contact end 722a. The second outer contact end 722b extends from an outermost face 727 to an inner face 729 of the second outer contact end 722b. Notably, the first outer contact end 722a and the second outer contact end 722b extend beyond the first outer inner end 712a and the second inner contact end 712b.

The medial inner portion 714 includes a divaricated cut section 711 with a plurality of divaricated cuts 716 and is also defined by a medial inner portion length, M_{IL7}, measured between inner faces 715, 719. Each divaricated cut in the inner compressible contact 710 is defined by at least one cut angle, as described with respect to FIGS. 1A-1C.

Defined in each inner contact end 712a, 722b is a divaricated-cut section 711, 711′ having a plurality of divaricated cuts 716, 716′. In this version of the outer compressible contact 720, at least three divaricated cuts are shown are shown in each contact end. However, additional divaricated cuts may be included, depending on application requirements.

The medial inner portion 724 is tubular, divaricated-cut free, defined by an inner diameter 724i and outer diameter 724o and a medial inner portion length, M_{OL7}, measured between inner faces 725, 729.

In the compressible electrical assembly 700, two dielectrics 730, 730′ are positioned between the inner compressible contact 710 and the outer compressible contact 720, as shown particularly in FIGS. 7B and 7C. Each dielectric 730, 730′ has a dielectric body 732, 732′ with a first body end 732a, 732a′ and a second body end 732b, 732b′ opposing the first body end 732a, 732a′. Each dielectric 730, 730′ is also defined by an inner diameter ID₇, ID_{7′} an outer diameter OD₇, OD_{7′} and a dielectric thickness T_{D7}, T_{D7′}.

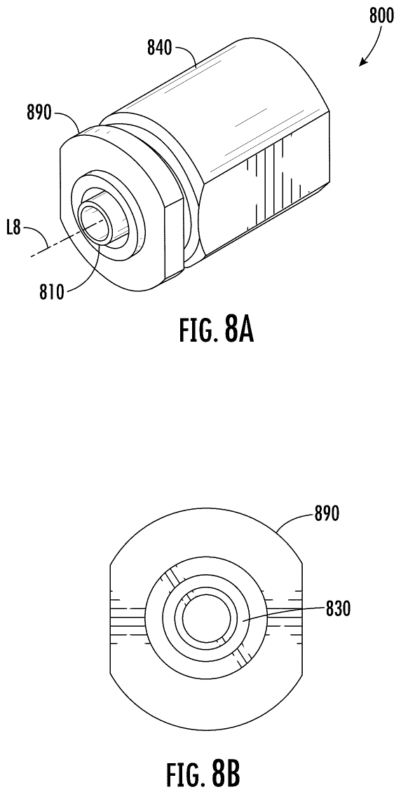

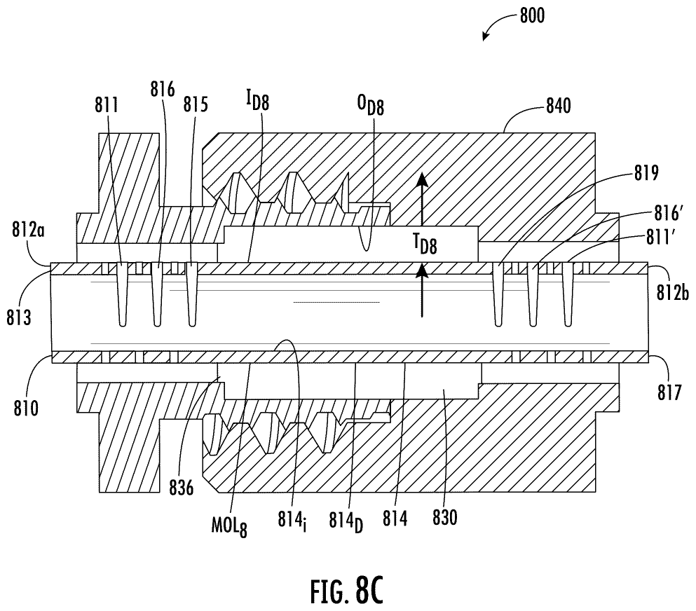

FIGS. 8A-8C illustrate another embodiment of a compressible electrical assembly 800, including an inner compressible contact 810, a forward housing 890, and a rearward housing 840 threaded with the forward housing 890. The inner compressible contact 810 is shown in a substantially relaxed state, with the dielectric 830 disposed between the inner compressible contact 810, the forward housing 890, and the rearward housing 840. Each element, as shown in the assembly, is shown arranged with respect to a common longitudinal axis L8.

Referring particularly to FIG. 8C, in this embodiment of the compressible electrical assembly 800, the inner compressible contact 810 includes a first inner contact end 812a, a second inner contact end 812b opposing the inner contact end, and a medial inner portion 814 positioned between the first inner contact end 812a and the second inner contact end 812b. The first inner contact end 812a extends from an outermost face 813 to an inner face 815. The second inner contact end 812b extends from an outermost face 817 to an inner face 819 of the second inner contact end 812b.

Defined in each inner contact end 812a, 812b is a divaricated-cut section 811, 811′ having a plurality of divaricated cuts 816, 816′. The medial inner portion 614 is tubular, divaricated-cut free, and defined by an inner diameter 614i and outer diameter 614o and a medial inner portion length, M_{OL8}, measured between inner faces 815, 819.

In the compressible electrical assembly 800, one dielectric 830 is positioned between the inner compressible contact 810, the forward housing 890, and the rearward housing 840, as shown particularly in FIGS. 8B and 8C. The dielectric 830 has a dielectric body 832 with a first body end 832a and a second body end 832b opposing the first body end 832a. In this configuration, the dielectric 830 has an overhang portion 836 and is also defined by an inner diameter ID₈, an outer diameter OD₈, and a dielectric thickness T_{D8}.

FIG. 8D shows an exemplary connector system 1300, which includes the compressible electrical assembly 800, housings 840, 890, and printed circuit boards 850a, 850b. Each housing 840, 890 helps to align the compressible electrical assembly 800 for signal transmission. Defined in the housing 840 are bores 842a, 842b. Each printed circuit board 850a, 850b includes a base 852a, 852b and an engagement element 854a, 854b that couple with the compressible electrical assembly 800. Also, each printed circuit board has at least one aperture 856a, 856b for positioning of contacts therein.

It will be apparent to those skilled in the art that various modifications and variations can be made without departing from the spirit or scope of the disclosed embodiments. Since modifications combinations, sub-combinations and variations of the disclosed embodiments, incorporating the spirit and substance of the embodiments may occur to persons skilled in the art, the disclosed embodiments should be construed to include everything within the scope of the appended claims and their equivalents.

What is claimed is:

1. A connector system, comprising:
a housing,
at least one compressible electrical assembly disposed in the housing, the at least one compressible electrical assembly comprising:
an inner compressible contact, comprising a first inner contact end, a second inner contact end opposing the first inner contact end, and a medial inner portion positioned between the first inner contact end and the second inner contact end;
an outer compressible contact, comprising a first outer contact end, a second outer contact end opposing the first outer contact end, and a medial outer portion positioned between the first outer contact end and the second outer contact end; and
a dielectric substantially disposed between the medial inner portion and the medial outer portion,
wherein defined in each of the first inner contact end, the second inner contact end, the first outer contact end, and the second outer contact end is a plurality of divaricated cuts, and
at least one printed circuit board coupled to the at least one compressible electrical assembly.

2. The connector system of claim 1, wherein the medial inner portion is substantially tubular.

3. The connector system of claim 1, wherein the medial outer portion is substantially tubular.

4. The connector system of claim 1, wherein a channel is defined in the dielectric.

5. The connector system of claim 4, wherein the channel is lateral and extends fully along the length of the dielectric.

6. The connector system of claim 1, wherein the first inner contact end extends beyond of the first outer contact end.

7. The connector system of claim 1, wherein the second inner contact end extends beyond the second outer contact end.

8. The connector system of claim 1, wherein the medial outer portion comprises a radially disposed crimped area centrally positioned along the length of the medial outer portion.

9. The connector system of claim 8, wherein the dielectric has a portion configured to be disposed within the radially disposed notch of the medial outer portion.

10. The connector system of claim 1, wherein the medial outer portion comprises a centrally disposed crimped section, having a curvature that extends inwardly toward the medial inner portion.

11. The connector system of claim 1, wherein the first outer contact end extends beyond the first inner contact end.

12. The connector system of claim 1, wherein the second outer contact end extends beyond the second inner contact end.

13. The connector system of claim 1, wherein the inner compressible electrical contact comprises a material selected from the group consisting of brass, copper, beryllium copper, and stainless steel.

14. The connector system of claim 1, wherein the outer compressible contact comprises a material selected from the group consisting of brass, copper, beryllium copper, and stainless steel.

15. The connector system of claim 1, wherein defined in the medial outer portion is an opening.

16. The connector system of claim 15, wherein a retaining element is at least partially contained in the opening.

17. The connector system of claim 1, wherein the dielectric comprises a first dielectric end and a second dielectric end opposing the first dielectric end and wherein the first dielectric end extends beyond the first inner contact end and the second dielectric end extends beyond of second inner contact end.

18. The connector system of claim 1, wherein each of the plurality of cuts is defined by at least one cut angle measured between a pair of opposing inner surfaces when in a substantially relaxed state, and wherein in a substantially compressed state, each pair of opposing inner surfaces collapses inwardly to form a slot.

19. The connector system of claim 1, wherein the dielectric comprises a first dielectric end and a second dielectric end and wherein the first dielectric end and the second dielectric end extend downwardly toward an inner diameter of the inner compressible contact.

20. A compressible electrical assembly, comprising:
an inner compressible contact, comprising a first inner contact end, a second inner contact end opposing the first inner contact end, and a medial inner portion positioned between the first inner contact end and the second inner contact end;
an outer compressible contact, comprising a first outer contact end, a second outer contact end opposing the first outer contact end, and a medial outer portion positioned between the first outer contact end and the second outer contact end; and
a dielectric substantially disposed between the medial inner portion and the medial outer portion,
wherein defined in the medial outer portion is a plurality of divaricated cuts, and wherein each of the plurality of cuts is defined by at least one cut angle measured between a pair of opposing inner surfaces when in a substantially relaxed state, and wherein in a substantially compressed state, each pair of opposing inner surfaces collapses inwardly to form a slot.
